(19) United States
(12) Patent Application Publication
(10) Pub. No.: US 2005/0148698 A1
(43) Pub. Date: Jul. 7, 2005

(54) Uv-resistant, thermocurable aminoplast composite, the production thereof and the use of the same

(76) Inventors: Manfred Ratzsch, Wilhering (AT); Daniel Jocham, Linz (AT); Uwe Muller, Luftenberg (AT); Wolfgang Haubold, Merseburg (DE)

Correspondence Address: THE WEBB LAW FIRM, P.C., 700 KOPPERS BUILDING, 436 SEVENTH AVENUE, PITTSBURGH, PA, 15219, US

(21) Appl. No.: 10/499,581

(22) PCT Filed: Dec. 12, 2002
(86) PCT No.: PCT/EP02/14169

(30) Foreign Application Priority Data
Dec. 20, 2001 (AT) A 2010/2001

(51) Int. Cl. C08L 1/00

(52) U.S. Cl. 524/35

(57) ABSTRACT

The invention relates to a UV-resistant, thermocurable aminoplast composite consisting of lignocellulose and/or cellulose impregnated with a stabiliser and an aminoplast containing stabilisers. The invention also relates to the production and use of said composite.

The invention relates to a UV-resistant thermocurable aminoplast composite, the production thereof and the use of the same.

The production of decorative laminates or surface-treated wood-based materials using mixtures of melamine resin condensates and urea resin condensates (DE 24 22 803 B1) or polyacrylates (DE 24 60 994 B2) is known. However, a disadvantage of these laminates is the low UV resistance thereof.

Known processes for improving the UV resistance of decorative laminates or surface-treated wood-based materials consist in the application of UV-resistant top layers of polyacrylates (DE 33 29 679 C1) or butyl rubber (EP 0 206 832 A2) to the aminoplast layers. The disadvantage of these top layers is the low scratch resistance thereof.

Furthermore, the addition of UV stabilizers to polymers is known. Thus, for example, WO 99/57189 states that extruded or biaxially oriented polymers, in particular polyolefins, have good UV stability if they contain a combination of certain stabilizers bound to polymer in a certain ratio to one another. These are polymer-bound sterically hindered amines (HALS) and UV absorbers—in a ratio of 5:1 to 10:1 to one another.

However, it has been found that, using the methods known to date, it is not possible to obtain UV stability of the surface which is also sufficient for outdoor applications for pure aminoplast composites which contain an aminoplast component and lignocellulose and/or cellulose.

Unexpectedly, a composition was found which has the desired properties in the cured state if, in addition to the aminoplast component, stabilizers are added to the lignocellulose and/or cellulose too.

The invention accordingly relates to a UV-resistant, thermocurable aminoplast composite consisting of lignocellulose and/or cellulose impregnated with stabilizer and of a stabilizer-containing aminoplast component.

The aminoplasts contained in the in the UV-resistant, thermocurable aminoplast composite are, for example, condensates of the melamine resin, urea resin, cyanamide resin, dicyandiamide resin or sulfonamide resin type, which may optionally contain 1-40% by mass, based on the mass of the condensate, of sheet silicates and/or further polymers of the type consisting of poly(meth)acrylates, polysiloxanes, polyesters, alkyd resins or optionally modified maleic anhydride copolymers.

Examples of melamine resins are in particular condensates of melamine or melamine derivatives and C₁-C₁₀-aldehydes having a molar melamine or melamine derivative/C₁-C₁₀-aldehydes ratio of 1:1 to 1:6 and partial etherification products thereof with C₁-C₁₀-alcohols, the melamine derivatives preferably being melamines, diaminomethyltriazines and/or diaminophenyltriazines substituted by hydroxy-C₁-C₁₀-alkyl groups, hydroxy-C₁-C₄-alkyl(oxa-C2-C4-alkyl)-1,5 groups and/or amino-C₁-C₁₂-alkyl groups, particularly preferably 2-(2-hydroxyethylamino)-4,6-diamino-1,3,5-triazine, 2-(5-hydroxy-3-oxapentylamino)-4,6-diamino-1,3,5-triazine and/or 2,4,6-tris(6-aminohexylamino)-1,3,5-triazine, ammeline, ammelide, acetoguanamine, caprinoguanamine and/or butyroguanamine, and the C₁-C₁₀-aldehydes preferably being formaldehyde, acetaldehyde, trimethylolacetaidehyde, acrolein, furfural, glyoxal and/or glutaraldehyde, particularly preferably formaldehyde.

The melamine resins may furthermore contain 0.1 to 10% by mass, based on the sum of melamine and melamine derivatives, of urea, and they may be etherified, for example methylated or butylated, with C₁-C₁₀-alcohols.

Examples of urea resins, in addition to urea/formaldehyde resins, are cocondensates with acid amides or sulfonamides. Examples of C₂-C₅-alkylcarboxyguanamine resins are resins which contain, as the guanamine component, acetoguanamine, caprinoguanamine and/or butyroguanamine.

The stabilizers contained in the UV-resistant, thermocurable aminoplast composite are UV absorbers and/or sterically hindered amines (HALS). Preferred stabilizers are HALS alone or combinations of HALS with UV absorbers, for example in the ratio of 5:1 to 1:5, preferably in the ratio 1:1 to 1:5.

They should be soluble or at least dispersible in water or in C₁-C₈-alcohols or mixtures thereof. Examples of sterically hindered HALS compounds are piperidine compounds and N-oxyl derivatives of piperidine compounds. Examples of UV stabilizers are 2-hydroxy-benzophenone derivatives, hydroxyphenylbenzotriazole derivatives, hydroxyphenyl-s-triazine derivatives, cinnamic acid derivatives and/or oxalanilides.

4-Hydroxytetramethylpiperidine and/or 4-aminotetramethylpiperidine are preferred, particularly preferably bis(2,2,6,6-tetramethyl-1-(octyloxy)-4-piperidinyl sebacate and/or etherified piperidine compounds, and furthermore N,N′-diformyl-N,N′-di(1-oxyl-2,2,6,6-tetramethyl-4-piperidinyl)-1,6-hexanediamine, 4-amino-2-hydroxybenzophenone, 2-hydroxy-4-sulfobenzophenone and/or 2,4-dihydroxybenzophenone, 2-(2,4-dihydroxy-phenyl)-2H-benzotriazole and/or 2-(2-hydroxy-4-sulfo)-2H-benzotriazole, particularly preferably (α-[3-[-(2H-benzotriazol-2-yl)-5-(1,1-dimethylethyl)-4-hydroxyphenyl]-1-oxo-propyl]-ω-hydroxypoly(oxo-1,2-ethanediyl) and/or sodium 3-(2H-benzotriazol-2-yl)-5-sec-butyl-4-hydroxybenzenesulfate, 2-(2-hydroxyphenyl)-4,6-(4-sulfophenyl)-1,3,5-triazine and/or 4,6-(4-aminophenyl)-2-(2-hydroxyphenyl)-1,3,5-triazine, 3-(4-hydroxyphenyl)-propenecarboxylic acid and/or 3-(4-hydroxyphenyl)-2-methylpropenecarboxylic acid, N,N′-(2-hydroxyphenyl)ethanediamide and/or N-(2-hydroxyphenyl)-N′-(4-sulfophenyl)-ethanediamide.

The UV-resistant, thermocurable aminoplast composite may also contain 1-40% by mass, based on the mass of the aminoplast component, of sheet silicates, and/or further polymers of the type consisting of melamine resin, urea resin, cyanamide resin, dicyandiamide resin or sulfonamide resin and/or further polymers of the type consisting of poly(meth)acrylates, polysiloxanes, polyesters, alkyd resins and optionally modified maleic anhydride copolymers.

Examples of sheet silicates are montmorillonite, bentonite, kaolinite, muscovite, hectorite, fluorohectorite, kanemite, revdite, grumantite, ilerite, saponite, beidelite, nontronite, stevensite, laponite, taneolite, vermiculite, halloysite, volkonskoite, magadite, rectorite, kenyaite, sauconite, borofluorophlogopites and/or synthetic smectites.

Examples of polyacrylates are copolymers based on functional unsaturated (meth)acrylate monomers, such as acrylic acid, hydroxyethyl acrylate, glycidyl acrylate, methacrylic acid, hydroxybutyl methacrylate or glycidyl methacrylate, and nonfunctional unsaturated (meth)acrylate monomers, such as ethyl acrylate, butyl acrylate, ethylhexyl acrylate, methyl methacrylate, ethyl acrylate and/or butyl methacrylate. Copolymers based on butyl methacrylate, hydroxyethyl acrylate and methyl methacrylate are preferred.

Examples of polysiloxanes are polycondensates of oligomeric organosiloxanes and alkoxysilanes or silicone polyesters based on silanediols, polybasic acids and polyols. Examples of polyesters are polyesters having molar masses of 2000 to 15 000, obtained from saturated dicarboxylic acids, such as adipic acid or succinic acid, unsaturated dicarboxylic acids, such as maleic acid, fumaric acid and/or itaconic acid, and diols, such as ethylene glycol, butanediol, neopentyl glycol and/or hexane diol. Branched polyesters based on neopentyl glycol, trimethylolpropane and azelaic acid are preferred.

Examples of alkyd resins are alkyd resins obtained from azelaic acid, neopentyl glycol, trimethylolethane and coconut oil or alkyd resins based on linear and branched fatty acid glycidyl esters, coconut oil fatty acids, trimethylolpropane, ethylene glycol and adipic anhydride.

Examples of maleic anhydride copolymers are C₂-C₂₀-olefin maleic anhydride copolymers. Examples of the C₂-C₂₀-olefin components which may be contained in the maleic anhydride copolymers are ethylene, propylene, but-1-ene, isobutene, diisobutene, hex-1-ene, oct-1-ene, hept-1-ene, pent-1-ene, 3-methylbut-1-ene, 4-methylpent-1-ene, methylethylpent-1-ene, ethylpent-1-ene, ethylhex-1-ene, octadec-1-ene and 5,6-dimethyl-norbornene. The modified maleic anhydride copolymers are preferably partially or completely esterified, imidated or amidated maleic anhydride copolymers.

Particularly suitable are modified copolymers of maleic anhydride and C₂-C₂₀-olefins having a molar ratio of 1:1 to 1:9 and weight average molar masses of 5000 to 500 000, which have been reacted with ammonia, C₁-C₁₈-monoalkylamines, aromatic C₆-C₁₈-monoamines, C₂-C₁₈-monoamino alcohols, monoaminated poly(C₂-C₄-alkylene) oxides having a molar mass of 400 to 3000, and/or monoetherified poly(C₂-C₄-alkylene) oxides having a molar mass of 100 to 10 000, the molar ratio of anhydride groups of the copolymer/ammonia, amino groups of C₁-C₁₈-monoalkylamines, C₂-C₁₈-monoamino alcohols or monoaminated poly(C₂-C₄-alkylene) oxide and/or hydroxyl groups of poly(C₂-C₄-alkylene) oxide being 1:1 to 20:1.

The stabilizer-impregnated lignocellulose and/or cellulose contained in the UV-resistant, thermocurable aminoplast composite may be present in the form of fibers, particles or sheet-like structures. Depending on the material used, their form and size may be very different. The fibers or particles may comprise wood, viscose, regenerated viscose, straw, flax, jute or kenaf, for example ground wood, cellulose powder or pulverulent lignocellulose. The preferred particle diameter is between 0.01 mm and 2 mm and the preferred fiber length is between 0.5 and 5 mm in the case of a preferred fiber diameter of 0.002 to 0.1 mm.

Examples of sheet-like structure are webs of paper or board, woven fabrics or nonwovens comprising lignocellulose, cellulose, regenerated cellulose, viscose or wood veneers, wood fiberboards or the surface of wood particle boards.

The invention furthermore relates to a process for the production of a UV-resistant, thermocurable aminoplast composite consisting of lignocellulose and/or cellulose impregnated with a stabilizer and a stabilizer-containing aminoplast, which is characterized in that
a) a solution or dispersion of an aminoplast is mixed with a stabilizer, optionally with 1-40% by mass, based on the mass of the aminoplast, sheet silicates and/or further polymers of the type consisting of poly(meth)acrylates, polysiloxanes, polyesters, alkyd resins or optionally modified maleic anhydride copolymers are added, and
b) lignocellulose and/or cellulose are impregnated with a solution or dispersion of a stabilizer and the solvent is removed, after which
   if the lignocellulose and/or cellulose impregnated with a stabilizer is a sheet-like structure, this is impregnated with the solution or dispersion of the aminoplast prepared under a), the solvent is removed and precuring is effected, resulting in the formation of a sheet-like prepreg, or
   if the lignocellulose and/or cellulose impregnated with a stabilizer comprises fibers or particles, this is mixed with the solution or dispersion of the aminoplast prepared under a), dried, and processed to give molding materials, such as pellets or granules, with further precuring.

For the production of the UV-resistant, thermocurable aminoplast composite, first one or more stabilizers, in the absence of a solvent or in solution/suspension, and at 15-90° C. and in a residence time of 3-30 min, are added to and homogenized with a solution or dispersion of an aminoplast in water, in a C1-C8-alcohol, such as methanol, ethanol, butanol or 1-methoxy-2-propanol or in a mixture of such solvents, preferably having a solids content of 50-70%.

1-40% by mass, based on the mass of the aminoplast, of sheet silicates and/or further polymers of the type consisting of poly(meth)acrylates, polysiloxanes, polyesters, alkyd resins or optionally modified maleic anhydride copolymers can optionally be added to this solution or dispersion.

Preferably, the reaction is carried out in stirred reactors at 20-50° C. and in a residence time of 5-15 minutes.

Lignocellulose and/or cellulose is then impregnated with a 1-5% strength solution or dispersion of one or more stabilizers in water, in C₁-C₈-alcohols or in mixtures thereof. If the cellulose and/or lignocellulose is a sheet-like structure, the impregnation of the lignocellulose and/or cellulose web is effected, for example, by immersion, spraying or application with a doctor blade. The solvent is then removed from the web coated with stabilizer, so that a coat of about 100-200 mg of stabilizer per m² is achieved.

In the case of sheet-like structures, the lignocellulose and/or cellulose web provided with stabilizers is then impregnated with the stabilizer-containing aminoplast present in solution. This impregnation can be effected in a plurality of steps, in dip baths, in spraying units or by applying the resin solution by means of a doctor blade. After the impregnation, the sheet-like structure is dried in a continuous drier at temperatures of 100-140° C. to a residual moisture content of 7-9%, based on the total weight. The residual moisture is determined by storage at 160° C. for 10 min. The prepregs thus produced can be further processed in various ways. A plurality of prepregs can be placed one on top of the other and cured together to give an aminoplast composite. Here, the prepregs which are in the interior of the composite need not be treated with stabilizers.

It is also possible to apply prepregs to other intermediate layers and press them together with these to give a composite.

Such intermediate layers are, for example, layers of wood fiberboards, wood particle boards, nonwovens or woven textile fabrics and unfoamed or foamed sheets or slabs of polyethylenes, polypropylenes, polystyrenes, polyesters, polyurethanes or polyamides or unfoamed or foamed slabs of thermosetting plastics, such as phenol resins, melamine resins, urea resins, cyanamide resins, dicyandiamide resins, sulfonamide resins, aniline resins or guanamine resins, or nonwovens or woven fabrics, sheets or slabs of cellulose derivatives, such as cellulose esters or cellulose ethers.

The curing is usually effected at temperatures of 120 to 240° C. and at pressures of 20 to 100 bar, depending on the aminoplast composition and layer structure of the prepregs and depending on the curing agent used. Depending on requirements, daylight presses having up to 20 platens, short-cycle presses or continuously operating belt presses are used for this purpose.

If the lignocellulose and/or cellulose is present in the form of particles or fibers, it is mixed with 1-5% strength solutions or dispersions of stabilizers in drum mixers, or alternatively in the absence of a solvent in kneaders or extruders, so that the particles or fibers preferably contain about 0.5-2% of stabilizer, based on the mass of particles or fibers. Thereafter, any solvent present is removed and the lignocellulose and/or cellulose impregnated with a stabilizer is mixed with the stabilizer-containing aminoplast which has likewise been freed from the solvent and to which curing agent and optionally further processing auxiliaries have been added, preferably in continuous kneaders, and dried in drying drums at temperatures below 80° C. The still uncured aminoplast composite can optionally be shaped into pellets or granules.

The curing of these pellets is effected with shaping to compression molded parts at 140-170° C. or injection molded parts at 155° C.-180° C.

The invention furthermore accordingly relates to a cured UV-resistant aminoplast composite as claimed in claim 1 and the use of a UV-resistant, thermocurable aminoplast composite as claimed in claim 1 for the production of one-layer or multilayer webs, such as decorative laminates, or of compression molded parts, injection molded parts or profiles, for example for application in the building industry, in particular for facade elements.

### EXAMPLE 1

Overlay paper having a basis weight of 20 g/m² was sprayed with an ethanolic solution of a UV absorber (Tinuvin 213 from Ciba Specialty Chemicals) and of a sterically hindered amine (Tinuvin 123 from Ciba Specialty Chemicals) and then dried. The content of stabilizers was 1% in both cases. 20 g of solution per m² were applied.

Solid melamine/formaldehyde resin (Lamelite 440 from Agrolinz Melamin Italia) was dissolved in equal parts of water and provided with 0.8% by weight of the curing agent Melpan A462 from Agrolinz Melamin Italia. 2% by weight of a UV absorber and 2% by weight of a sterically hindered amine were added to the resin solution.

The previously treated overlay paper was impregnated with this resin solution so that a resin coat of about 120% of resin, based on the paper, was present. The impregnated paper webs were dried with hot air to 140° to a residue moisture content of about 8% to give a prepreg. This prepreg was pressed as the top layer of a multilayer composite consisting, apart from the overlay paper, of a white stabilizer-free, phenol resin-impregnated décor paper prepreg having a basis weight of 80 g/m², impregnated with Lamelite 440, and two impregnated soda kraft papers having a basis weight of 180 g/m² and a further overlay prepreg as a counteracting paper. The papers were pressed in a laboratory press between two chromium-plated press plates polished to a high gloss, at a temperature of 150° C. and a pressure of 80 kg/cm² and for a press time of 2 minutes and with recooling to 70° C., to give an aminoplast composite.

Test specimens were artificially weathered in an Atlas Weatherometer 1200CPS, and the photooxidation on the surface was observed by means of infrared spectroscopy and assessed. In particular, the bands in the carbonyl range from 1750 cm⁻¹ to 1680 cm⁻¹ were used for this purpose.

A reduction of the intensities of the carbonyl bands by about 90% in comparison with a stabilizer-free aminoplast composite and by about 50% compared with test pieces in which only the resin was stabilized was found.

### EXAMPLE 2

White décor paper having a basis weight of 80 g/m² was sprayed with a solution of a UV absorber (Tinuvin 1130 from Ciba Specialty Chemicals) and of a sterically hindered amine (N,N′-diformyl-N,N′-di-(1-oxyl-2,2,6,6-tetramethyl-4-piperidinyl)-1,6-hexane-diamine) in isopropanol and then dried. The stabilizer content was 1% in both cases. About 20 g of solution per m² were applied.

This décor paper is preimpregnated with a commercially available melamine/formaldehyde resin (Lamelite 440 from Agrolinz Melamin Italia, having a melamine/formaldehyde ratio of 1:1.6) and dried at 140° C. in a drying tunnel for 30 sec. 0.5% of a wetting agent (Melpan NU117 from Agrolinz Melamin) and 0.8% of the curing agent (Melpan A462 from Agrolinz Melamin) are added to the resin.

The impregnated paper is further impregnated in a second impregnating bath with a 50% strength solution of a methyl-etherified melamine/formaldehyde condensate in butanol. 5% of a maleic anhydride/styrene copolymer (molar ratio 2:1), which was reacted with an ethanolamine to give the monoamide and with ammonia to give the ammonium salt, were added to this butanolic solution. Furthermore, 1% each of a UV absorver (Tinuvin 1130 from Ciba Specialty Chemicals) and of a sterically hindered amine (Tinuvin 123 from Ciba Specialty Chemicals) are added.

The doubly impregnated décor paper is dried again in a tubular oven at 140° C. until the residual proportion of volatile components has decreased to 7%, based on dried paper. This determination is effected on storage of the paper for 10 min at 160° C. The total resin coat is 95% of the resin, based on the paper weight.

The paper thus impregnated serves as a top layer of a multilayer composite consisting of the top layer, two conventional phenol resin-impregnated soda kraft core papers and a counteracting paper. The composite is pressed at 160° C. and a specific weight per unit area of 80 bar and for a press time of 8 minutes and with recooling to 70° C. after the lapse of 8 minutes in a laboratory press between two chromium-plated press plates polished to a high gloss to give an aminoplast composite.

During artificial weathering for 1000 h in an Atlas Weatherometer 1200CPS, it was possible to determine a reduction of 85% in the formation of carbonyl groups by photoreactions, and one of about 40% compared with the test pieces in which only the resin was stabilized, by means of infrared spectroscopy.

### EXAMPLE 3

2% of the UV absorber sodium 3-(2H-benzotriazol-2-yl)-5-sec-butyl-4-hydroxybenzene-sulfonate and 2% of the N-oxyl N,N′-diformyl-N,N′-di(1-oxyl-2,2,6,6-tetramethyl-4-piperidinyl)-1,6-hexanediamine and 1% of the curing agent Melpan A462 from Agrolinz Melamin were added to a butanolic solution of an organophilic methyl-etherified melamine/formaldehyde precondensate (solids content 45% by mass). From the solution modified in this manner, the UV-stabilized solid resin was isolated by evaporating off the solvent.

100 parts by weight of spruce wood chips (Lignocel S 8-15, J. Rettenmaier & Söhne) were sprayed in a heatable mixer with 10 parts by weight of a 2% strength methanolic solution consisting of sodium 3-(2H-benzotriazol-2-yl)-5-sec-butyl-4-hydroxybenzene-sulfonate and 2% of the N-oxyl N,N′-diformyl-N,N′-di(1-oxyl-2,2,6,6-tetramethyl-4-piperidinyl)-1,6-hexanediamine and then dried for 90 min at 90° C. 100 parts parts by weight of the spruce wood chips thus impregnated are then compounded in a kneader with 20 parts by weight of the UV-stabilized organophilic melamine resin at 100° C. The compound was then pressed under a high-pressure press at a temperature of 180° C. and a load of 50 kg/cm² and in a press time of 2 min to give a test piece.

The test piece thus produced was then subjected to artificial accelerated weathering in an Atlas Weatherometer 1200 CPS for 1000 h. For assessing the UV stability, the formation of carbonyl bands in the range of 1750 cm⁻¹ to 1650 cm⁻¹ was used. The intensity of the bands in the carbonyl range is about 5% compared with the stabilizer-free test pieces weathered under identical conditions and about 50% compared with the test pieces in which only the resin was stabilized.

### EXAMPLE 4

2% of the UV absorber α-{3-[3-(2H-benzotriazol-2-yl)-5-(1,1-dimethylethyl)-4-hydroxy-phenyl]-1-oxopropyl}-ω-hydroxypoly(oxo-1,2-ethanediyl) and 2% of the N-oxyl N,N′-diformyl-N,N′-di(1-oxyl-2,2,6,6-tetraethyl-4-piperidinyl)-1,5-pentanediamine and 1% of the curing agent Melpan A462 from Agrolinz Melamin were added to a butanolic solution of an organophilic methyl-etherified melamine/butyroguanamine/formaldehyde preconden-sate (molar melamine/butyroguanamine ratio 6:1; solids content 48% by mass). From the solution modified in this manner, UV-stabilized solid resin was isolated by evaporating off the solvent.

100 parts by weight of spruce wood chips (Lignocel S 8-15, J. Rettenmaier & Söhne) were sprayed in a heatable mixer with 5 parts by weight of a 2.5% strength methanolic solution consisting of α-{3-[3-(2H-benzotriazol-2-yl)-5-(1,1-dimethylethyl)-4-hydroxyphenyl]-1-oxopropyl}-cohydroxypoly-oxo-1,2-ethanediyl) and N,N′-diformyl-N,N′-di(1-oxyl-2,2,6,6-tetraethyl-4-piperidinyl)-1,5-pentanediamine and then dried for 90 min at 90° C. 100 parts by weight of the spruce wood chips thus impregnated are then compounded in a kneader with 20 parts parts by weight of the UV-stabilized organophilic amine resin at 100° C. The compound were then pressed under a high-pressure press at a temperature of 185° C. and a load of 50 kg/cm² and in a press time of 2 min to give a test piece.

The test piece thus produced was then subjected to artificially accelerated weathering in a weatherometer (Atlas Weatherometer 1200 CPS) for 1000 h. For assessing the UV stability, the formation of carbonyl bands in the range from 1750 cm⁻¹ to 1650 cm⁻¹ was used. The intensity of the bands in the carbonyl range is about 6.5% compared with the stabilizer-free test piece weathered under identical conditions and about 55% compared with the test pieces in which only the resin was stabilized.

### EXAMPLE 5

Spruce wood veneer was impregnated for 30 min in a 2% strength methanolic solution consisting of sodium 3-(2H-benzotriazol-2-yl)-5-sec-butyl-4-hydroxybenzenesulfonate and N,N′-diformyl-N,N′-di(1-oxyl-2,2,6,6-tetramethyl-4-piperidinyl)-1,6-hexanediamine and then dried in a vacuum drying oven for 40 min at 85° C. The veneer treated in this manner was subsequently coated with an aqueous solution consisting of 50% of an organophilic methyl-etherified melamine/formaldehyde precondensate, 2% of the UV absorber sodium 3-(2H-benzotriazol-2-yl)-5-sec-butyl-4-hydroxybenzenesulfonate and 2% of the N-oxyl N,N′-diformyl-N,N′-di(1-oxyl-2,2,6,6-tetramethyl-4-piperidinyl)-1,6-hexanediamine and 1% of the curing agent Melpan A462 from Agrolinz Melamin and dried.

The impregnated veneer was then cured in a high-pressure press at a temperature of 150° C. and a load of 50 kg/cm² and in a press time of 2 min.

The veneer thus produced was then subjected to artificial accelerated weathering in an Atlas Weatherometer 1200 CPS for 1000 h. For assessing the UV stability, the formation of carbonyl bands in the range from 1750 cm⁻¹ to 1650 cm⁻¹ was used. The intensity of the bands in the carbonyl range is about 10% compared with the stabilizer-free veneer weathered under identical conditions and about 60% compared with the veneer in which only the resin was stabilized.

### EXAMPLE 6

Spruce wood veneer was impregnated for 30 min in 2% strength methanolic solution consisting of ethyl 3-(2H-benzotriazol-2-yl)-5-(1,1-dimethylethyl)-4-hydroxybenzenepropanoate and bis(2,2,6,6-tetramethyl-1-(octyloxy)-4-piperidyl sebacate and then dried in a vacuum drying oven for 40 min at 85° C. The veneer thus treated was subsequently coated with an aqueous solution consisting of 50% of an organophilic methyl-etherified melamine/urea/formaldehyde precondensate (molar melamine/urea ratio 7:1), 2% of the UV absorber ethyl 3-(2H-benzotriazol-2-yl)-5-(1,1-dimethylethyl)-4-hydroxybenzenepropanoate and 2% of bis(2,2,6,6-tetramethyl-1-(octyloxy)-4-piperidyl sebacate and 1% of the curing agent Melpan A462 from Agrolinz Melamin and dried.

The impregnated veneer was then cured under a high-pressure press at a temperature of 160° C. and a load of 50 kg/cm² and in a press time of 2.5 min.

The veneer thus produced was then subjected to artificial accelerated weathering in an Atlas Weatherometer 1200 CPS for 1000 h. For assessing the UV stability, the formation of carbonyl bands in the range from 1750 cm⁻¹ to 1650 cm⁻¹ was used. The intensity of the bands in the carbonyl range is about 15% compared with the stabilizer-free veneer weathered under identical conditions and about 65% compared with the veneer in which only the resin was stabilized.

1-10. (canceled)

11. A UV-resistant, thermocurable aminoplast composite consisting of
at least one of lignocellulose and cellulose impregnated with a stabilizer and
stabilizer-containing aminoplast, wherein the stabilizer comprises at least one of a UV absorber and a sterically hindered amine (HALS).

12. The UV-resistant, thermocurable aminoplast composite as claimed in claim 11, wherein the at least one of lignocellulose and cellulose impregnated with a stabilizer and the stabilizer-containing aminoplast is a sheet-like structure selected from the group consisting of paper, board, a woven fabric, nonwoven fabric, and a wood veneer.

13. The UV-resistant, thermocurable aminoplast composite as claimed in claim 11, wherein the at least one of lignocellulose and cellulose impregnated with a stabilizer is selected from the group consisting of wood fibers, particles of wood, viscose, regenerated viscose, straw, flax, jute, and kenaf, which is impregnated with a stabilizer and is a mixture with the stabilizer-containing aminoplast, and is optionally pressed to give pellets or granules.

14. The UV-resistant, thermocurable aminoplast composite as claimed in claim 11, wherein the stabilizer is soluble or dispersible in water or in C₁-C₈-alcohols.

15. The UV-resistant, thermocurable aminoplast composite as claimed in claim 11, wherein the stabilizer-containing aminoplast is selected from the group consisting of melamine resin, urea resin, cyanamide resin, dicyandiamide resin, and sulfonamide resin type, which optionally contains 1-40% by mass, based on the mass of the aminoplast, of at least one of sheet silicates and further polymers of the type selected from the group consisting of poly(meth)acrylates, polysiloxanes, polyesters, alkyd resins, and optionally modified maleic anhydride copolymers.

16. A process for the production of an aminoplast composite as claimed in claim 11, wherein
a) a solution or dispersion of an aminoplast is mixed with a stabilizer, optionally with 1-40% by mass, based on the mass of the aminoplast, of at least one of sheet silicates and further polymers of the type selected from the group consisting of poly(meth)acrylates, polysiloxanes, polyesters, alkyd resins, and optionally modified maleic anhydride copolymers is added and
b) at least one of lignocellulose and cellulose is impregnated with a solution or dispersion of a stabilizer and the solvent is removed, after which
if the at least one of cellulose and lignocellulose impregnated with a stabilizer is a sheet-like structure, the at least one of cellulose and lignocellulose is impregnated with the solution or dispersion of the aminoplast prepared under a) and the solvent is removed, resulting in the formation of a sheet-like prepreg, or
if the at least one of cellulose and lignocellulose impregnated with a stabilizer comprises fibers or particles, the at least one of cellulose and lignocellulose is mixed with the aminoplast prepared under a), dried and optionally processed to give pellets or granules.

17. A process for the production of a UV-resistant, thermocurable aminoplast composite, wherein at least one sheet-like prepregs, consisting of at least one of lignocellulose and cellulose impregnated with a stabilizer and of a stabilizer-containing aminoplast, optionally together with at least one stabilizer-free intermediate layers of plastic, of at least one of cellulose and lignocellulose, of at least one of cellulose and lignocellulose impregnated with at least one of stabilizer-free aminoplast and phenol resin, are cured to give an aminoplast composite.

18. A process for the production of a UV-resistant, thermocured aminoplast composite, wherein a mixture of fibers or particles impregnated with a stabilizer and comprising at least one of cellulose and lignocellulose with a stabilizer-containing aminoplast, optionally after pressing to give pellets or granules, is cured with further shaping.

19. The cured, UV-resistant aminoplast composite as claimed in claim 11.

20. The UV-resistant, thermocurable aminoplast composite as claimed in claim 11, used for the production of one-layer or multilayer webs selected from the group consisting of decorative laminates, compression-molded parts, injection-molded parts, and profiles.
